(19) United States
(12) Patent Application Publication
(10) Pub. No.: US 2011/0244829 A1
(43) Pub. Date: Oct. 6, 2011

(54) DEVICE REGISTRATION METHOD AND DEVICE REGISTRATION SYSTEM

(76) Inventor: Hiroshi KASE, Osaka (JP)

(21) Appl. No.: 13/074,236

(22) Filed: Mar. 29, 2011

(30) Foreign Application Priority Data
Mar. 30, 2010 (JP) 2010-078328

(51) Int. Cl. H04M 1/66

(52) U.S. Cl. 455/411

(57) ABSTRACT

A device registration method for a system including a registering apparatus and a first and a second device, includes storing, by the first device, first information which is information about an individual, sending, by the second device, second information to the first device, the second information being information about an individual, determining, by the first device, whether the second information received from the second device matches the first information, when, as a result of the determination, the second information matches the first information, instructing, by the first device, the registering apparatus to register access permission for the second device so that the second device is allowed to access the registering apparatus, and when the registering apparatus receives the instruction, registering, by the registering apparatus, access permission for the second device so that the second device can access the registering apparatus.

### BACKGROUND

1. Technical Field

The present invention relates to a device registration method and a device registration system for so-called digital home appliances such as digital cameras, mobile phones with camera functions, televisions, and recorders.

2. Related Art

In recent years, networks have become widespread even in general households, and electronic devices connectable to networks, such as televisions, recorders, and digital cameras, have been sold. Users can connect these electronic devices to a network to share data, thus improving user convenience.

In a link between devices through a network, in view of preventing unauthorized access, and so on, a so-called “pairing” which is a process of registering a device accessible to a certain device is required. Conventionally, a pairing is performed, for example, as follows. First, a device that performs registration of access permission searches for devices connected to a network. The device that performs registration of access permission presents a list of a plurality of devices found on the network to the user. The device that performs registration of access permission registers a device selected by the user from the list, for access permission. In this method, for authentication between devices, the user needs to perform several operations, including setting the device that performs registration of access permission to registration mode, selecting a counterpart device from the presented device list, and entering a password. JP2000-151871A discloses a technique in which such a device list is held in advance and a counterpart device is selected from the held device list and then authentication between devices is performed.

The above-described conventional method, causes the user to know beforehand which item in the device list is associated with which device. Thus, the method is not user friendly.

The present invention is made to solve the above-described problem, and therefore an object of the present invention is to provide a user-friendly device registration method and device registration system.

### SUMMARY

In a first aspect of the present invention, a device registration method is provided for a system including a registering apparatus and first and second devices. According to the device registration method, the first device stores first information which is information about an individual. The second device sends second information which is information about an individual, to the first device. The first device determines whether the second information received from the second device matches the first information. As a result of the determination, when the second information matches the first information, the first device instructs the registering apparatus to register access permission for the second device so that the second device is allowed to access the registering apparatus. When the registering apparatus receives the instruction, the registering apparatus registers access permission for the second device so that the second device can access the registering apparatus.

In a second aspect of the present invention, a device registration method is provided for a system including a first and a second device. The first device stores first information. The second device sends second information to the first device. The first device determines whether the second information received from the second device matches the first information. As a result of the determination, when the second information matches the first information, the first device registers permission for connection of the second device to the first device.

In a third aspect of the present invention, a device registration system is provided. The device registration system includes a first device including a storage unit that stores first information which is information about an individual, a second device including a sending unit that sends second information which is information about an individual, and a registering apparatus that performs registration of access permission. The second device sends the second information to the first device. The first device includes a determining unit that determines whether the second information received from the second device matches the first information, and a sending unit that sends an instruction to the registering apparatus to register access permission for the second device so that the second device is allowed to access the registering apparatus, when the second information matches the first information as a result of the determination.

In a fourth aspect of the present invention, an electronic device is provided. The electronic device includes: a storage unit that stores first information which is information about an individual, a receiving unit that receives second information which is information about an individual, from another device; a determining unit that determines whether the second information matches the first information, and a sending unit that sends an instruction to a registering apparatus to register access permission for the another device so that the another device is allowed to access the registering apparatus, when the second information matches the first information as a result of the determination.

According to the present invention, designation of a counterpart device and authentication by a password can be performed using information (e.g., face information) relating to an individual (e.g., the owner of a registering apparatus), and thus device registration can be completed by intuitive operations, improving user convenience.

Furthermore, after completing the device registration, the face information used for the device registration is associated with an application to be executed subsequently, and thus an effective way of enjoying contents can be provided to users.

### BRIEF DESCRIPTION OF DRAWINGS

FIG. 1 is a diagram showing an example of a connection relationship between devices in an embodiment.

FIG. 2 is a block diagram showing a configuration of a mobile phone (a registration authentication device) in the embodiment.

FIG. 3 is a block diagram showing a configuration of a mobile phone (a device to be registered) in the embodiment.

FIG. 4 is a sequence diagram showing a pairing sequence (case 1) in the embodiment.

FIG. 5 is a sequence diagram showing a pairing sequence (case 2) in the embodiment.

FIG. 6 is a sequence diagram describing a link operation performed between a television and the mobile phones.

FIG. 7 is a sequence diagram describing another link operation performed between the television and the mobile phones.

### DETAILED DESCRIPTION OF PREFERRED EMBODIMENT

An embodiment of the present invention is described below with reference to the drawings. The embodiment below describes a device registration method for registering one device (a device to be registered) on another device (a registering apparatus) so that the one device can access another device, and a system that implements the device registration method. In particular, in the present embodiment, information about a predetermined person (e.g., the owner of the registering apparatus) is used as authentication information of the device to be registered in device registration. By this, device registration can be performed with simple operations, as will be described later, enabling to improve user convenience in device registration.

### First Embodiment

### 1. Configuration

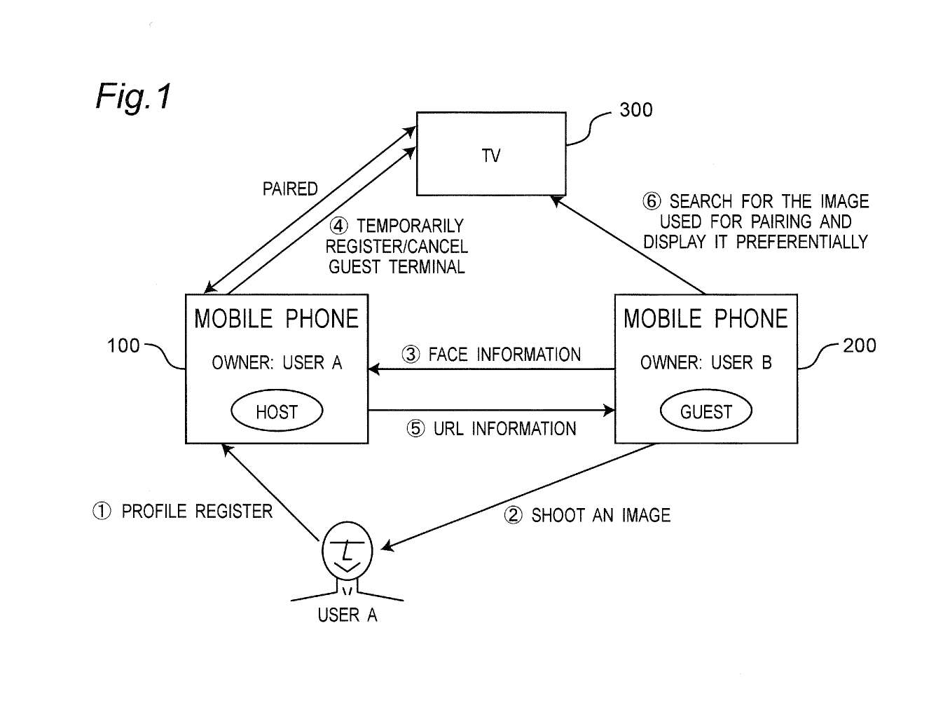

FIG. 1 is a diagram showing an example of connection between devices in a first embodiment of the present invention. A mobile phone 100, a mobile phone 200, and a television 300 are connectable through a network (e.g., a wireless LAN). The television 300 has a function of receiving images from the mobile phones 100 and 200 and displaying the received images on a screen.

1.1 Preconditions

In description described later, the following conditions are assumed.

An owner of the television 300 and the mobile phone 100 is user A, and an owner of the mobile phone 200 is user B who is a friend of user A. The television 300 is in the user A's home, and a pairing between the mobile phone 100 and the television 300 has been completed so that photos (images) can be displayed on the television 300 from the mobile phone 100. As described above, the pairing is a process which is required for security in performing communication through a network and is provided for registering access permission of one device (the mobile phones 100 and 200) to the other device (e.g., the television 300). To execute a photo viewing application (described later) on the television 300, pairings between the television 300 and the mobile phones 100 and 200 need to be completed. It is assumed that a pairing between the mobile phone 200 and the mobile phone 100 has been completed, but a pairing between the mobile phone 200 and the television 300 has not been performed yet.

Under the above-described assumption, the case will be described in which user B visits the user A's home, and user A and user B display images recorded in their mobile phones on the television 300 to enjoy viewing the images. In this case, a photo viewing application is executed on the television 300, the mobile phone 100, and the mobile phone 200. The photo viewing application is an application allowing images stored on the mobile phone 100 and the mobile phone 200 to be viewed on the television 300.

Note that although in the following, for simplification of description, user B has only one mobile phone 200, the configuration is not limited thereto and there may be one or more other mobile phones equivalent to the mobile phone 200. Namely, the idea described below can also be applied to the case in which a plurality of friends bring their mobile phones to the user A's home, or the case in which a single friend brings a plurality of his/her mobile phones to the user A's home.

Note also that, although the description is provided using a television and mobile phones as examples of system's components, as a device corresponding to the television 300, a video playback apparatus, such as an optical disc player, a video recording apparatus, such as an optical disc recorder or a hard disk recorder, or an information processing apparatus, such as a personal computer, may be used. Note also that, as devices corresponding to the mobile phones 100 and 200, imaging apparatuses, such as digital cameras or movie cameras, or information processing apparatuses, such as PDAs (Personal Digital Assistants) or personal computers, may be used. Namely, as devices corresponding to the mobile phones 100 and 200, devices having an image shooting function and a communication function are considered.

### 1.2 Configuration of Mobile Phones

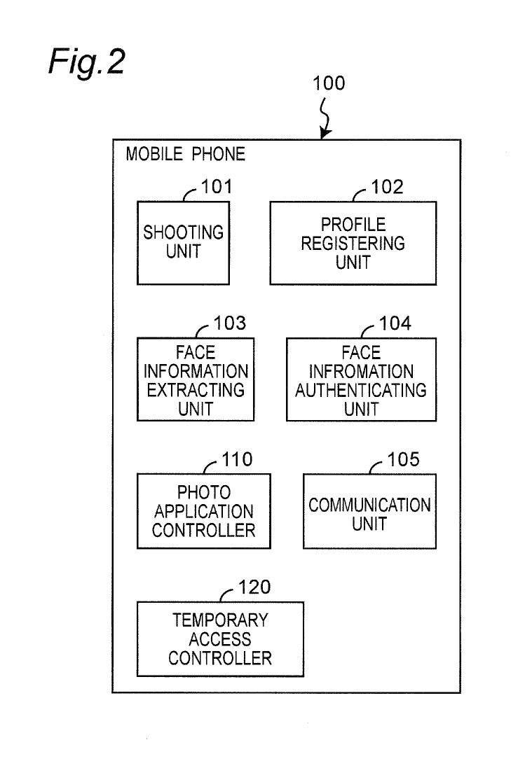

A configuration of the user A's mobile phone 100 will be described using FIG. 2. FIG. 2 is a block diagram showing a configuration of the mobile phone 100.

The mobile phone 100 includes a shooting unit 101, a profile registering unit 102, a face information extracting unit 103, a face information authenticating unit 104, a communication unit 105, a photo application controller 110, and a temporary access controller 120.

The shooting unit 101 is a unit that controls the shooting function of the mobile phone 100. The shooting unit 101 includes a lens, an imaging device, a memory, a display, software that controls these components, and so on.

The profile registering unit 102 is a means of registering the owner's profile information of the mobile phone 100 in the mobile phone 100. In the present embodiment, as the owner's profile information, information on an owner's face image is stored in the memory. The profile registering unit 102 is realized by a control program that records information on an owner's face image shot by the shooting unit 101 in a predetermined area of the memory and hardware (a CPU, or the like) that executes the control program. Note that the information recorded here may be an image which is shot or may be face information which is information representing the features of the face and is extracted by the face information extracting unit 103 which is described later.

The face information extracting unit 103 is realized by a program for extracting a portion which is considered a face from an image and extracting a predetermined parameter, as face information, which corresponds to the features of the face, and hardware (a CPU, or the like) that executes the program.

The face information authenticating unit 104 is realized by a program for comparing an image or face information sent through the communication unit 105 which is described later with the face image or face information registered by the profile registering unit 102 to determine whether the persons in the respective images are identical, and hardware (a CPU, or the like) that executes the program.

The communication unit 105 is realized by a network interface and a communication processing program for communicating with other devices such as the television 300 and another mobile phone 200.

The photo application controller 110 is realized by a program for controlling a photo viewing application which is an application for displaying images recorded in the mobile phone 100 on an external device, such as the television 300, through the communication unit 105, and hardware (a CPU, or the like) that executes the program.

The temporary access controller 120 is implemented by a control program for allowing temporary access by which images can be temporarily displayed on the television 300 from another mobile phone which has not been paired with the television 300 at home, and hardware (a CPU, or the like) that executes the control program.

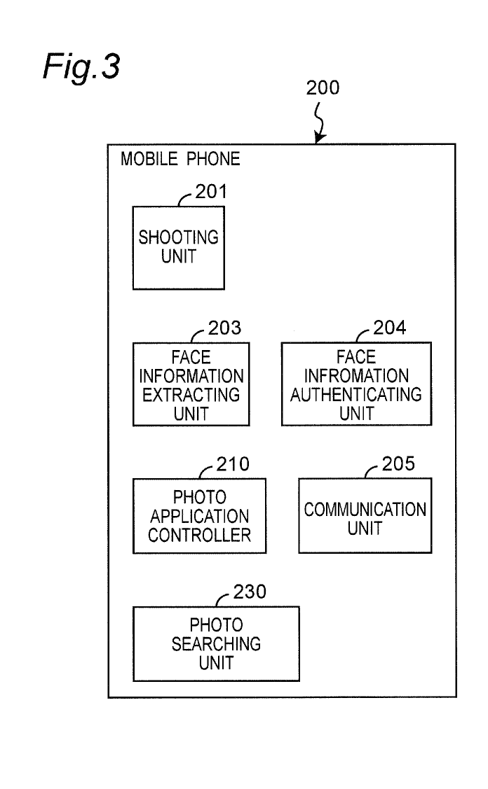

Next, a configuration of the user B's mobile phone 200 is described using FIG. 3. FIG. 3 is a block diagram showing a configuration of the mobile phone 200 in the first embodiment of the present invention.

The mobile phone 200 includes a shooting unit 201, a face information extracting unit 203, a face information authenticating unit 204, a communication unit 205, a photo application controller 210, and a photo searching unit 230.

The shooting unit 201 is a unit for controlling the shooting function of the mobile phone 200. The shooting unit 201 includes a lens, an imaging device, a memory, a display, software for controlling these components, or the like.

The face information extracting unit 203 is realized by a program for extracting a portion considered a face from an image obtained by the shooting unit 201, and extracting a predetermined parameter, as face information, which corresponds to the features of the face, and hardware (a CPU, or the like) that executes the program.

The face information authenticating unit 204 is realized by a program for sending the image shot by the shooting unit 201 or the face information extracted by the face information extracting unit 203 to an external device, such as the mobile phone 100, through the communication unit 205 which will be described later, and receiving an authentication result indicating whether the person in the shot image is the owner of the external device; and hardware (a CPU, or the like) that executes the program.

The communication unit 205 is realized by a network interface and a communication processing program for communicating with other devices such as the television 300 and the mobile phone 100, and hardware (a CPU, or the like) that executes the communication processing program.

The photo application controller 210 is realized by a program for controlling a photo viewing application for displaying images recorded in the mobile phone 200 on an external device, such as the television 300, through the communication unit 205, and hardware (a CPU, or the like) that executes the program.

The photo searching unit 230 is realized by a program for searching the images recorded in the mobile phone 200 for images containing a face that matches the face information extracted from the image shot by the shooting unit 201; and hardware (a CPU, or the like) that executes the program.

Note that, although for convenience of explanation the mobile phone 100 and the mobile phone 200 have different configurations, the mobile phone 100 and the mobile phone 200 may have the same configuration as long as they hold all of the above-described means as components.

### 2. Operation

### 2.1 Pairing Procedure

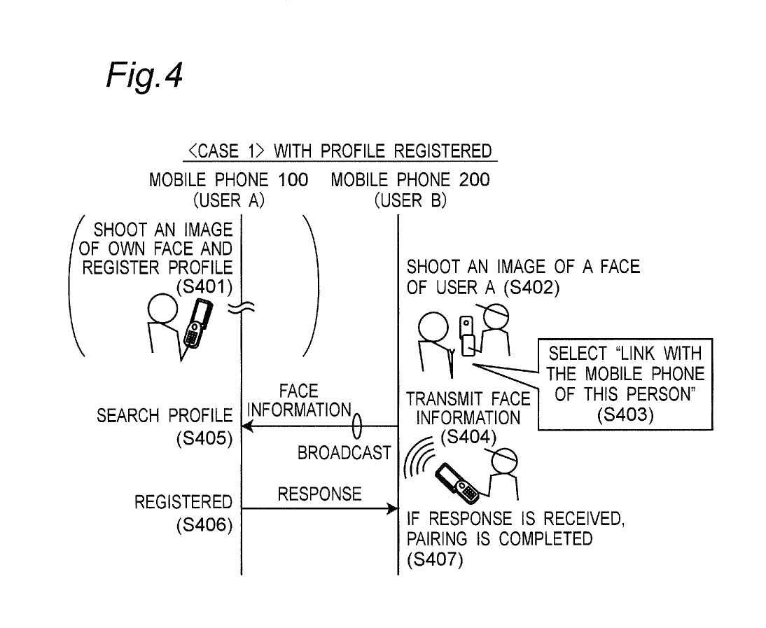

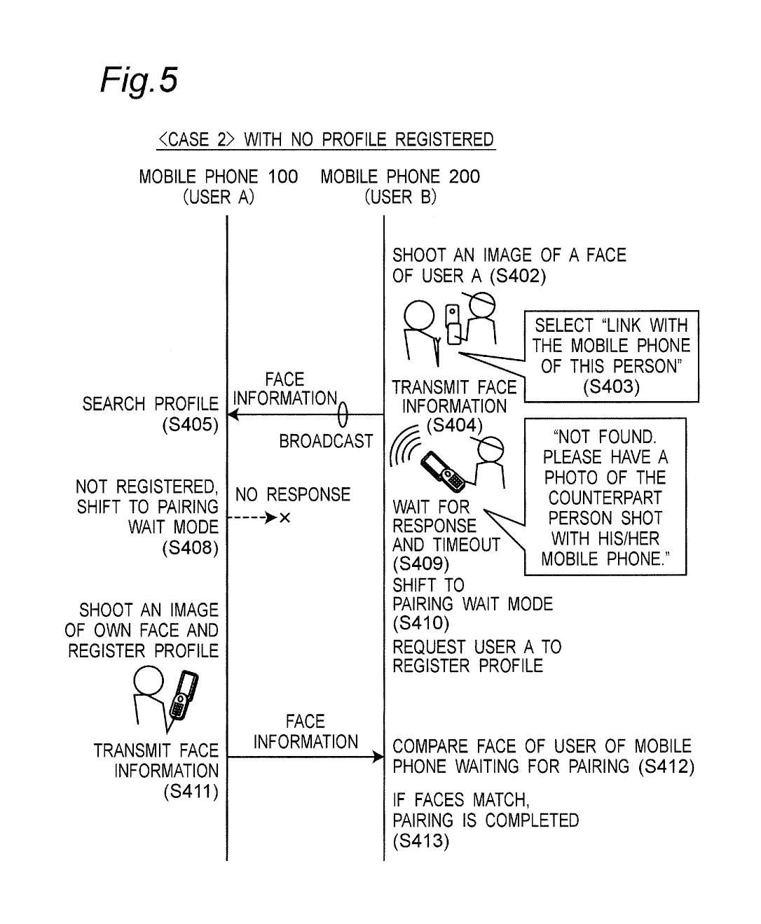

A pairing procedure between mobile phones is described using FIGS. 4 and 5. FIGS. 4 and 5 are sequence diagrams showing a pairing procedure in the first Embodiment of the present invention.

2.1.1 Pairing Procedure for the Case in which there is Profile Registration

First, a pairing procedure is described for the case in which the mobile phone 100 has profile registration (registration of profile information) of user A who is the owner of the mobile phone 100 (case 1). FIG. 4 is a diagram showing a pairing procedure for the case in which there is profile registration (case 1). Note that, to start a pairing, user A who is the owner of the mobile phone 100 has shot an image of his/her face and has already completed profile registration on the mobile phone 100 (S401). At this time, the image shot by the shooting unit 101 is saved in the mobile phone 100 by the profile registering unit 102. Profile registration only needs to be performed once in advance and thus does not need to be performed every time a pairing is performed.

In starting a pairing, user B shoots a user A's face with the mobile phone 200 (S402). The shot image is displayed on the display of the shooting unit 201. At that time, several options are displayed as processes to be performed on the shot image, including an option “Link with the mobile phone of this person”. When that option is selected by user B (S403), the face information extracting unit 203 extracts face information of the shot image, and the face information authenticating unit 204 broadcasts the face information onto the network through the communication unit 205 (S404) to search for a device having profile information including face information corresponding to the broadcast face information. Note that images shot with the mobile phones 100 and 200 are preferably still images but may be moving images.

The mobile phone 100 receives the face information broadcast from the mobile phone 200 through the communication unit 105 and determines, by the face information authenticating unit 104, whether the face information matches the owner registered in the profile information (S405). Specifically, the face information extracting unit 103 extracts face information from the image included in the profile information, and the face information authenticating unit 104 compares the extracted face information with the received face information. If the extracted face information matches the received face information, i.e., if the person of the received face information matches the person registered in the profile information, then the face information authenticating unit 104 returns a response indicating “there is registration” to the mobile phone 200 through the communication unit 105 (S406). At this time, the face information authenticating unit 104 registers a MAC address of the mobile phone 200.

The mobile phone 200 receives the response indicating “there is registration” from the mobile phone 100, and thereby recognizes that the pairing with the mobile phone 100 has been completed (S407). When the completion of the pairing is recognized, the mobile phone 200 registers a MAC address of the mobile phone 100.

When the mobile phone 100 has profile registration, a pairing is performed in the above-described manner.

2.1.2 Pairing Procedure for the Case in which there is No Profile Registration

Next, the case in which user A has not performed profile registration in advance on the mobile phone 100 (case 2), i.e., the case in which the process at step S401 has not been performed yet, is described using FIG. 5.

In FIG. 5, the processes at steps S402 to S405 are the same as those in FIG. 4. Since there is no profile registration on the mobile phone 100, as a result of the process at step S405, there is no corresponding face information and thus the face information authenticating unit 104 does not return a response, and the mobile phone 100 transitions to pairing wait mode (S408). The pairing wait mode is cancelled after a lapse of a predetermined time.

On the other hand, the face information authenticating unit 204 having waited for a response from another device after sending face information (S404) stops waiting for reception of a response after a lapse of a predetermined time (S409). At this time, the mobile phone 200 provides display saying, for example, “Not found. Please have a photo of the counterpart person shot with his/her mobile phone” to urge the user to perform profile registration on the mobile phone 100, and transitions to the pairing wait mode (S410).

User B who is the owner of the mobile phone 200 requests user A to perform profile registration, and in response to the request, user A performs profile registration on the mobile phone 100. At this time, the profile registering unit 102 of the mobile phone 100 performs profile registration of the shot face image, and when the mobile phone 100 is in the pairing wait mode, face information is extracted from the face image by the face information extracting unit 103 and sent to the mobile phone 200 through the communication unit 105 (S411). At this time, the face information authenticating unit 104 registers the MAC address of the mobile phone 200. By this, the pairing is completed on the mobile phone 100. Note that at step S411 the face information may be sent only when a predetermined condition is satisfied. The predetermined condition may be, for example, that a face is included in a shot image. In addition, the face information may be multicast or broadcast onto the network, instead of being sent (unicast) only to the mobile phone 200 from which face information is received previously.

In the case in which the mobile phone 200 is in the pairing wait mode at step S410, when the mobile phone 200 receives face information from the other device through the communication unit 205, the face information authenticating unit 204 compares the received face information with the face information which is used for the search at step S404 to see whether they match (S412). If they match, then the mobile phone 200 registers the MAC address of the mobile phone 100 and completes the pairing with the mobile phone 100 (S413).

In the above-described manner, a pairing process between mobile phones can be completed using, as authentication information, a face image of the owner of a device, enabling to exchange images between the mobile phones. As described above, in the present embodiment, a pairing is completed only by shooting a face image and sending information on the face image, and thus the user can perform intuitive operations and user convenience can be improved.

2.2 Link Operation between Television and Mobile Phones

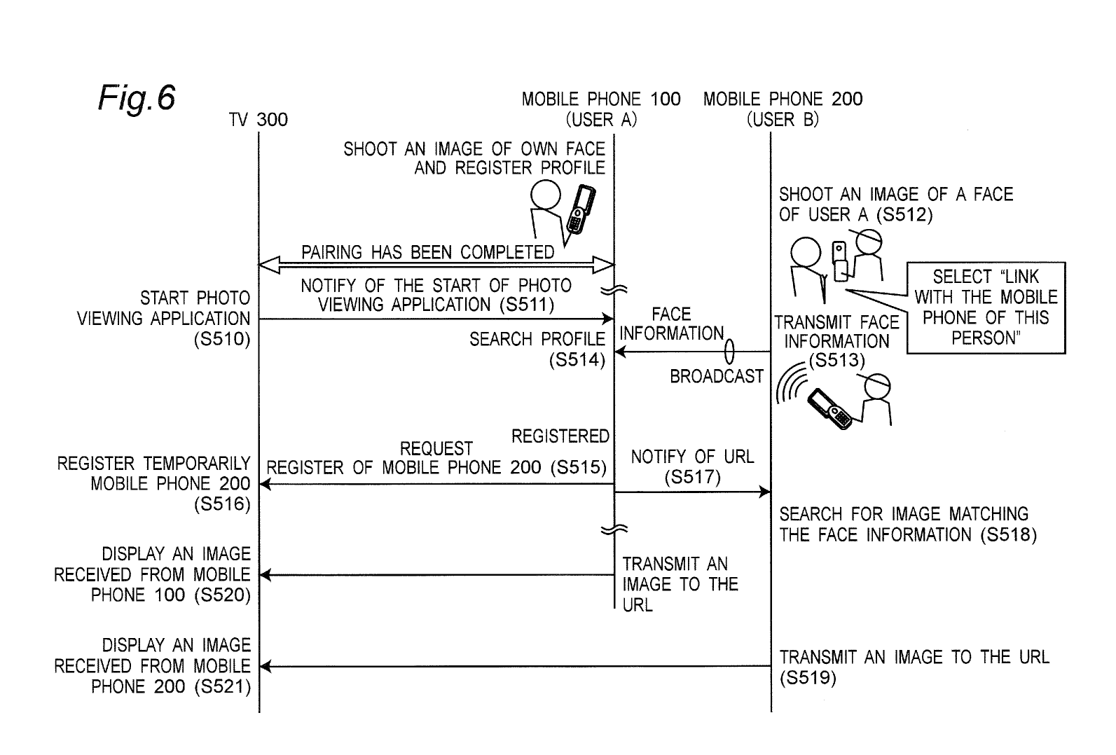

The link operation performed between the television 300 and the mobile phones 100 and 200 is described using FIG. 6. FIG. 6 is a sequence diagram describing the link operation performed between the television 300 and the mobile phones 100 and 200 in the present embodiment. To achieve the link operation described below, the mobile phones 100 and 200 need to send images to the television 300, and a photo viewing application which is software for implementing the function of displaying the images on the television 300 needs to be started on the television 300.

It is assumed that the pairing between the television 300 (an example of a registering apparatus) and the mobile phone 100 (an example of a first device) has been completed. The pairing between the television 300 and the mobile phone 100 may be performed by a conventional technique. In addition, it is assumed that profile registration has been performed in advance on the mobile phone 100.

First, a photo viewing application is started on the television 300 (S510). When the photo viewing application is started on the television 300, the television 300 notifies the mobile phone 100 having been paired with the television 300, of the start of the photo viewing application (S511), and also displays a message saying, for example, “Please have a face photo of the host user shot by the guest user” on the screen of the television 300. Here, the guest user is user B who is the owner of the mobile phone 200, and the host user is user A who is the owner of the mobile phone 100.

A face image of user A who is the owner of the mobile phone 100 is shot with the mobile phone 200 (S512). The mobile phone 200 extracts face information from the shot image, and broadcasts the face information onto the network to search a device that holds data matching the face information (S513).

The mobile phone 100 determines whether the received face information matches the content of the registered profile information (S514). If they match, then the mobile phone 100 requests the television 300 for registration of the mobile phone 200 to permit access to the television 300 by the mobile phone 200 (S515). At the same time, the mobile phone 100 notifies the mobile phone 200 of connection information required to access the television 300, e.g., a URL (Uniform Resource Locator) of the television 300 (S517). Note that the mobile phone 100 may display a confirmation screen to confirm user B who is the owner of the mobile phone 200 whether it is allowed to register the mobile phone 200 on the television 300, before requesting the television 300 for registration of the mobile phone 200 (S515) and notifying the mobile phone 200 of the URL of the television 300 (S517). Then, only when user B's intention to register is confirmed, the mobile phone 100 may request the television 300 for registration of the mobile phone 200 (S515) and notify the mobile phone 200 of the URL of the television 300 (S517).

When the television 300 receives the request for registration from the mobile phone 100, the television 300 temporarily registers the mobile phone 200 (S516). By this registration, the mobile phone 200 is allowed to access the television 300.

When the mobile phone 200 receives the URL from the mobile phone 100, the mobile phone 200 determines that access permission to the television 300 has been registered, and thus, prepares images to be displayed on the television 300. Specifically, the photo searching unit 230 of the mobile phone 200 searches the images recorded in the mobile phone 200 for images having face information that matches the face information of the image shot at step S512 (S518), and sends the searched images to the television 300 on a priority basis over other images by referring to the received URL (S519). Note that the image to be sent to the television 300 is not limited to the image having face information matching the face information of the image previously shot in the mobile phone 200, but may be any image that can be sent by the mobile phone 200.

When the television 300 receives images from the mobile phone 100 and the mobile phone 200 whose access thereto is permitted, the television 300 displays the received images on the screen (S520 and S521).

Since the mobile phone 200 is temporarily registered on the television 300, when the photo viewing application is terminated on the television 300, the registration of the mobile phone 200, i.e., the access permission for the mobile phone 200, is cancelled on the television 300.

### 3. Summary

As described above, in the present embodiment, the mobile phone 100 performs authentication of the mobile phone 200 (the device to be registered) using information on an individual (e.g., a face image of the owner of the television 300). When the validity of the mobile phone 200 is confirmed, the mobile phone 100 instructs the television 300 (the registering apparatus) to register access permission for the mobile phone 200. By this, a mobile phone which belongs to a guest user can be easily and temporarily registered on a television which belongs to a host user, and thus, photos shot by each of users can be easily shared between the users on the television. Thus, user convenience is improved. In addition, since the temporary registration is automatically cancelled upon termination, the access right of the guest user can be prevented from remaining, thus improving safety.

### 4. Term Correspondence

The television 300 is an example of a registering apparatus. The mobile phone 100 is an example of a first device and an electronic device. The mobile phone 200 is an example of a second device. A face image or face information extracted from the face image is an example of information about an individual (i.e., first and second information). A phone number or an email address is also another example of the information about an individual.

### Other Embodiments

Although one embodiment of the present invention is described above, the idea of the present invention is not limited thereto. Other embodiments of the idea of the present invention will be described below.

(1) In the first embodiment, face information extracted from a shot image is used as information to be broadcast as authentication information by the mobile phone 200. However, instead of the face information, the shot image itself may be broadcast as authentication information. In this case, a terminal (mobile phone 100) having received the image is configured to extract face information from the image. Furthermore, in this case, the terminal (mobile phone 100) having received the image may refer to information on the shooting date and time of the image If the shooting date and time are older, by a predetermined period, than the current date and time, then the terminal may determine that the image does not have reliability and thus may not perform a profile search (5405 and 5514).

(2) Alternatively, as authentication information, personal information (an email address, a phone number, etc.) may be broadcast from the mobile phone 200. In this case, the mobile phone 100 may have, as profile information, an email address, a phone number, etc., registered therein and perform a profile search based on the personal information received from the mobile phone 200.

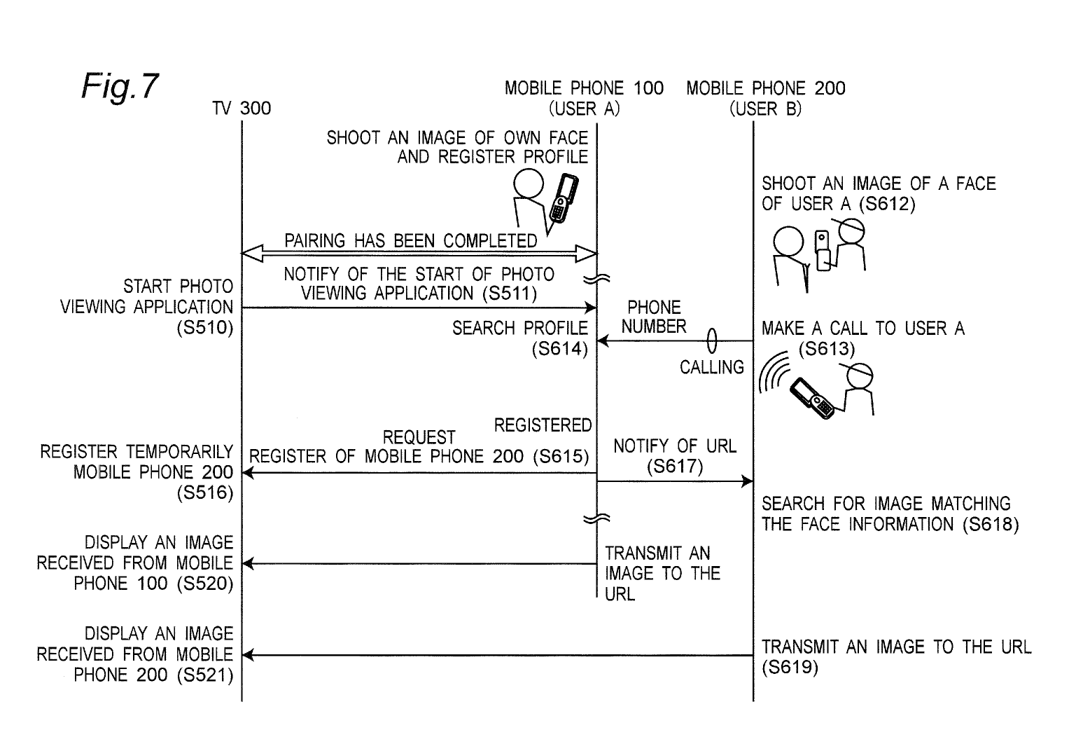

For example, when a phone number is used as authentication information, instead of the procedure shown in FIG. 6, a procedure shown in FIG. 7 may be considered. Specifically, after shooting the face of user A with the mobile phone 200 (S612), the mobile phone 200 makes a phone call to the mobile phone 100 (S613). When the mobile phone 100 receives the call from the mobile phone 200, the mobile phone 100 performs a profile search based on an incoming phone number (S614). Concretely, the mobile phone 100 checks whether the incoming phone number is registered in an address book managed by the mobile phone 100. If the incoming phone number is registered in the address book, then the mobile phone 100 determines that a profile is registered, and thus, requests the television 300 for registration of the mobile phone 200 (S615). Along with it, the mobile phone 100 searches for an email address registered in the address book in association with the phone number, and sends the URL of the television 300 to the email address (S617). The mobile phone 200 searches for images that match face information extracted from the shot face image (S618) and sends the searched images to the received URL (S619). Note that the image to be sent is not limited to the image having face information matching the face information of the image previously shot in the mobile phone 200, but may be any image that can be sent by the mobile phone 200.

In this case, since the mobile phone 200 makes a phone call to the mobile phone 100 using the phone number of the mobile phone 100, it is considered that, as authentication information, the phone number of the owner (user A) of the mobile phone 100, i.e., the television 300, is used. By such a method, too, authentication of the mobile phone 200 (the device to be registered) can be performed using information about the owner (user A) of the television 300 (the registering apparatus).

(3) Although, in the above-described embodiment, the mobile phone 100, the mobile phone 200, and the television 300 are connected to one another through a network (e.g., a wireless LAN), sending and receiving of face information and image data may be sent and received by infrared communication. Alternatively, a removable recording medium such as a USB memory or an SD card may be used for sending and receiving of face information and image data.

(4) Although, in the above-described embodiment, personal information (e.g., a face image) on the owner of the television (the registering apparatus) 300 is used as authentication information, instead of the personal information on the owner of the television (the registering apparatus) 300, personal information on a person who can authorize to instruct the television (the registering apparatus) 300 to permit registration may be used.

(5) In the above-described embodiment, a mobile phone is used as one example of a device to be registered. However the device to be registered is not limited to the mobile phone. It is understood that a electronic device which has wireless communication function can be the device to be registered. For example, conventionally, there is a digital camera which has a wireless communication function, and such a digital camera can be one of the devices to be registered.

### INDUSTRIAL APPLICABILITY

The present invention is useful for device registration and a photo viewing application for so-called digital home appliances such as digital cameras, mobile phones with camera functions, televisions, and recorders.

What is claimed is:

1. A device registration method for a system including a registering apparatus and a first and a second device, the method comprising:
storing, by the first device, first information which is information about an individual;
sending, by the second device, second information to the first device, the second information being information about an individual;
determining, by the first device, whether the second information received from the second device matches the first information;
when, as a result of the determination, the second information matches the first information, instructing, by the first device, the registering apparatus to register access permission for the second device so that the second device is allowed to access the registering apparatus; and
when the registering apparatus receives the instruction, registering, by the registering apparatus, access permission for the second device so that the second device can access the registering apparatus.

2. The device registration method according to claim 1, wherein in the instructing, when the second information matches the first information, further the first device sends connection information of the registering apparatus to the second device.

3. The device registration method according to claim 2, further comprising:
establishing an connection, by the second device, with the registering apparatus according to the connection information received from the first device; and
sending, by the second device, an image to the registering apparatus after establishing the connection with the registering apparatus.

4. The device registration method according to claim 3, wherein, in the sending an image to the registering apparatus, the second device sends an image extracted from stored images using the second information as a search key.

5. The device registration method according to claim 1, wherein the information about an individual is an image containing a face of the individual or information indicating features of a face extracted from the image.

6. The device registration method according to claim 1, wherein the information about an individual is a phone number or an email address of the individual.

7. The device registration method according to claim 1, wherein the registering apparatus is either one of a video display apparatus, a video playback apparatus, and a video recording apparatus.

8. The device registration method according to claim 1, wherein the first device and/or the second device is either one of a mobile phone and an imaging apparatus.

9. A device registration method for a system including a first and a second device, the method comprising:
storing, by the first device, first information;
sending, by the second device, second information to the first device;
determining, by the first device, whether the second information received from the second device matches the first information; and
when, as a result of the determination, the second information matches the first information, registering, by the first device, permission for connection of the second device to the first device.

10. The device registration method according to claim 9, wherein the first and second information is an image containing a face of an individual or information indicating features of a face extracted from the image.

11. A device registration system comprising:
a first device including a storage unit that stores first information which is information about an individual;
a second device including a sending unit that sends second information which is information about an individual; and
a registering apparatus that performs registration of access permission, wherein
the second device sends the second information to the first device, and
the first device comprises:
a determining unit that determines whether the second information received from the second device matches the first information; and
a sending unit that sends an instruction to the registering apparatus to register access permission for the second device so that the second device is allowed to access the registering apparatus, when the second information matches the first information as a result of the determination.

12. The device registration system according to claim 11, wherein, when the second information matches the first information, the first device further sends connection information of the registering apparatus to the second device.

13. The device registration system according to claim 12, wherein the second device establishes a connection with the registering apparatus according to the connection information received from the first device, and thereafter, sends an image to the registering apparatus.

14. The device registration system according to claim 11, wherein the information about an individual is an image containing a face of the individual or information indicating features of a face extracted from the image.

15. The device registration system according to claim 11, wherein the information about an individual is a phone number or an email address of the individual.

16. The device registration system according to claim 11, wherein the registering apparatus is either one of a video display apparatus, a video playback apparatus, and a video recording apparatus.

17. The device registration system according to claim 11, wherein the first device and/or the second device is either one of a mobile phone and an imaging apparatus.

18. An electronic device comprising:
a storage unit that stores first information which is information about an individual;
a receiving unit that receives second information from another device, the second information being information about an individual;
a determining unit that determines whether the second information matches the first information; and
a sending unit that sends an instruction to a registering apparatus to register access permission for the another device so that the another device is allowed to access the registering apparatus, when the second information matches the first information as a result of the determination.

19. The electronic device according to claim 18, wherein the information about an individual is an image containing a face of the individual or information indicating features of a face extracted from the image.

20. The electronic device according to claim 18, wherein the electronic device is either one of a mobile phone and an imaging apparatus.
